(19) United States
(12) Patent Application Publication
(10) Pub. No.: US 2025/0250420 A1
(43) Pub. Date: Aug. 7, 2025

(54) METHOD FOR PRODUCING RUBBER COMPOSITION

(71) Applicant: Toyo Tire Corporation, Itami-shi (JP)

(72) Inventor: Shotaro Miwa, Itami-shi (JP)

(73) Assignee: Toyo Tire Corporation, Itami-shi (JP)

(21) Appl. No.: 19/003,431

(22) Filed: Dec. 27, 2024

(30) Foreign Application Priority Data
Feb. 1, 2024 (JP) 2024-013912

(51) Int. Cl. C08K 5/548; C08K 3/36

(52) U.S. Cl. CPC C08K 5/548; C08K 3/36

(57) ABSTRACT

A method for producing a rubber composition containing a diene-based rubber, silica, an organic silane, and a sulfur-containing silane coupling agent other than the organic silane, wherein the organic silane is a compound having a terpene skeleton with a molecular weight of 200 to 1000, the method comprising: a first step in which at least the diene-based rubber, the silica, and the sulfur-containing silane coupling agent are mixed to obtain a rubber composition before remilling; and a second step in which the rubber composition before remilling and the organic silane are mixed.

### BACKGROUND OF THE INVENTION

### Field of the Invention

The present invention relates to a method for producing a rubber composition.

### Description of the Related Art

Pneumatic tires are designed to run under various conditions, and it is absolutely necessary to improve tire performance on, for example, wet roads (hereinafter also referred to as “WET performance”). Further, due to a recent request for resource saving, pneumatic tires are required to be fuel-efficient and are therefore also required to have improved low heat build-up contributing to fuel-efficiency. In addition, from the viewpoint of improving durability, pneumatic tires are also required to have wear resistance.

Patent Document 1 mentioned below discloses a rubber composition for tires containing a diene-based rubber, silica, a sulfur-containing silane coupling agent, and a specific alkyltriethoxysilane, wherein 50 mass % or more of the diene-based rubber is a styrene-butadiene copolymer rubber, the sulfur-containing silane coupling agent has a mercapto group, a content of the silica is 5 to 150 parts by mass per 100 parts by mass of the diene-based rubber, a content of the sulfur-containing silane coupling agent is 3 to 15 mass % relative to the content of the silica, and a content of the alkyltriethoxysilane is 0.1 to 20 mass % relative to the content of the silica.

Patent Document 2 mentioned below discloses a rubber composition containing 100 parts by mass of a diene-based rubber, 20 to 150 parts by mass of silica, and an organic silane having a monosulfide bond (—C—S—C—) in an amount of 2 to 20 mass % relative to the mass of the silica.

Patent Document 3 mentioned below discloses a rubber composition containing: a diene-based rubber containing a modified diene-based rubber modified with at least one functional group selected from the group consisting of an alkoxy group, a carbonyl group, a hydroxyl group, an amino group, and an epoxy group; silica; and an organic silane having a low-molecular-weight terpene skeleton, wherein the silica is contained in an amount of 30 to 120 parts by mass per 100 parts by mass of the diene-based rubber, and the organic silane is contained in an amount of 2 to 20 mass % relative to the mass of the silica.

### PRIOR ART DOCUMENT

### Patent Documents

Patent Document 1: JP-B2-4930661
Patent Document 2: JP-B2-6018001
Patent Document 3: JP-B2-6377476

### SUMMARY OF THE INVENTION

Both of Patent Documents 1 and 2 mentioned above disclose techniques to achieve both WET performance and fuel-efficiency of pneumatic tires. However, as a result of intensive studies, the present inventor has found that these techniques have room for improvement because WET performance and fuel-efficiency have a trade-off relationship.

It should be noted that Patent Document 3 mentioned above discloses a technique in which an organic silane having a low-molecular-weight terpene skeleton is contained in a rubber composition, but as a result of intensive studies, the present inventor has found that this technique has room for improvement as will be described later.

In light of such circumstances, it is an object of the present invention to provide a method for producing a rubber composition for use as a raw material of a vulcanized rubber for tires achieving a good balance among improved three performances: WET performance, fuel-efficiency, and wear resistance.

The above object can be achieved by the following configurations. Specifically, the present invention relates to a method (1) for producing a rubber composition containing a diene-based rubber, silica, an organic silane, and a sulfur-containing silane coupling agent other than the organic silane, wherein the organic silane is a compound having a terpene skeleton with a molecular weight of 200 to 1000, the method including: a first step in which at least the diene-based rubber, the silica, and the sulfur-containing silane coupling agent are mixed to obtain a rubber composition before remilling; and a second step in which the rubber composition before remilling and the organic silane are mixed.

The method (1) for producing a rubber composition is preferably a method (2) for producing a rubber composition, in which the organic silane is a compound represented by the following general formula (1):

[Formula 1]

X [symbol] S—CₙH₂ₙ—SiR¹R²R³]ₘ (1)
(wherein R¹, R², and R³ are each an alkyl group having 1 to 3 carbon atoms or an alkoxy group having 1 to 3 carbon atoms, at least one of R¹, R², and R³ is an alkoxy group, n is an integer of 2 to 4, X is a group having a terpene skeleton with a molecular weight of 200 to 1000, an intramolecular carbon-carbon double bond that X has is saturated or unsaturated, and X optionally contains a hetero element).

The method (1) or (2) for producing a rubber composition is preferably a method (3) for producing a rubber composition, in which the organic silane is a product of an ene-thiol reaction between a compound represented by the following general formula (2):

[Formula 2]

HS—CₙH₂ₙ—SiR¹R²R³ (2)
(wherein R¹, R², R³, and n are the same as those in the above formula (1)) and at least one compound selected from the group consisting of a compound represented by the following general formula (3a):

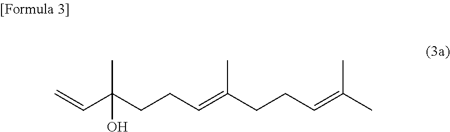

a compound represented by the following general formula (3b):

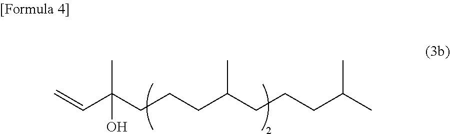

and a compound represented by the following general formula (3c).

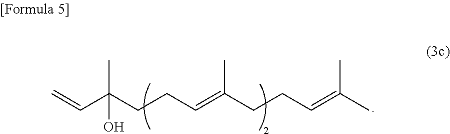

Any one of the methods (1) to (3) for producing a rubber composition is preferably a method (4) for producing a rubber composition, in which in the first step, the silica is mixed in an amount of 30 to 150 parts by mass when an entire amount of the diene-based rubber is taken as 100 parts by mass and the sulfur-containing silane coupling agent is mixed in an amount of 1 to 15 mass % of the amount of the silica, and in the second step, the organic silane in an amount of 10 to 300 mass % of the amount of the sulfur-containing silane coupling agent is mixed with the rubber composition before remilling.

When silica is contained in a rubber composition as a reinforcing agent, particularly when a large amount of silica is contained, the filling effect of the silica tends to be insufficient due to deterioration in dispersibility of the silica in a rubber. Therefore, in order to improve dispersibility of silica in a rubber, various organic silanes (silane coupling agents) have been used. However, as a result of intensive studies, the present inventor has found that even when such an organic silane having heretofore been used is contained in a rubber together with silica, flexibilization of the interface between the rubber and the silica is insufficient, and therefore it is difficult to improve WET performance and fuel-efficiency of a vulcanized rubber to be finally obtained in a balanced way.

On the other hand, a rubber composition produced by the method for producing a rubber composition according to the present invention contains, in addition to a diene-based rubber and silica, a compound having a terpene skeleton with a molecular weight of 200 to 1000 as an organic silane. The terpene skeleton with a molecular weight of 200 to 1000 of the organic silane has high affinity for the diene-based rubber, and therefore when the terpene skeleton lies at the interface between the diene-based rubber and the silica, the interface between them can be flexibilized at a high level. In addition, the terpene skeleton with a molecular weight of 200 to 1000 can hydrophobize the surface of the silica at a high level, which makes it possible to improve dispersibility of the silica in the diene-based rubber. As a result of these, WET performance and fuel-efficiency of a vulcanized rubber of a rubber composition produced by the method for producing a rubber composition according to the present invention are improved in a balanced way due to excellent dispersibility of the silica in the rubber and a very flexible interface between them. In addition, the rubber composition produced by the method for producing a rubber composition according to the present invention further contains, in addition to the organic silane having a terpene skeleton with a molecular weight of 200 to 1000, a sulfur-containing silane coupling agent other than the organic silane. This improves three performances: wear resistance as well as WET performance and fuel-efficiency in a balanced way.

However, as a result of intensive studies, the present inventor has found that when a rubber composition is produced by mixing an organic silane having a terpene skeleton with a molecular weight of 200 to 1000 and a sulfur-containing silane coupling agent other than the organic silane with silica at the same time, the both competitively react with hydroxyl groups on the surface of the silica so that the amount of bonding between the sulfur-containing silane coupling agent and the silica is reduced, which may make the effect of improving the wear resistance of a vulcanized rubber to be finally obtained insufficient. Finally, as a result of more intensive studies, the present inventor has found that the wear resistance of a vulcanized rubber to be finally obtained is sufficiently improved by producing a rubber composition through two steps separately performed: a first step in which at least a diene-based rubber, silica, and a sulfur-containing silane coupling agent are mixed to obtain a rubber composition before remilling; and a second step in which the rubber composition before remilling and an organic silane having a terpene skeleton with a molecular weight of 200 to 1000 are mixed.

It should be noted that the technique disclosed in Patent Document 3, in which an organic silane having a low-molecular-weight terpene skeleton is contained in a rubber composition, contributes to improved dispersibility of the silica in the rubber to some extent but insufficiently achieves flexibilization of the interface between the diene-based rubber and the silica. The study focused on the flexibility of the interface between a diene-based rubber and silica is the first of its kind as far as the present inventor is aware and, of course, there is neither description nor suggestion in Patent Document 3. Further, in Patent Document 3, there is neither description nor suggestion about mixing of an organic silane having a terpene skeleton with a molecular weight of 200 to 1000 with silica and mixing of a sulfur-containing silane coupling agent other than the organic silane with silica are performed in different steps.

A vulcanized rubber of a rubber composition obtained by the method for producing a rubber composition according to the present invention achieves a good balance among improved three performances: WET performance, fuel-efficiency, and wear resistance. Therefore, a vulcanized rubber of a rubber composition obtained by the method for producing a rubber composition according to the present invention is particularly useful for pneumatic tire treads.

### DETAILED DESCRIPTION OF THE PREFERRED EMBODIMENTS

A method for producing a rubber composition according to the present invention uses, as raw materials, a diene-based rubber, silica, an organic silane, and a sulfur-containing silane coupling agent other than the organic silane.

Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These diene-based rubbers may be used singly or in combination of two or more of them.

Examples of the silica to be used include silicas usually used for rubber reinforcement, such as wet silica, dry silica, sol-gel silica, and surface-treated silica. Among these, wet silica is preferred. From the viewpoint of improving WET performance and fuel-efficiency of the vulcanized rubber, the amount of the silica contained is preferably 30 to 150 parts by mass, more preferably 50 to 120 parts by mass when the entire amount of the diene-based rubber contained in the rubber composition is taken as 100 parts by mass.

The method for producing a rubber composition according to the present invention is characterized in that the rubber composition contains, as an organic silane, a compound having a terpene skeleton with a molecular weight of 200 to 1000. If the molecular weight of the terpene skeleton of the organic silane is less than 200 or exceeds 1000, WET performance and fuel-efficiency tend to be insufficiently improved due to insufficient flexibilization of the interface between the diene-based rubber and the silica. In the present invention, the amount of the organic silane contained in the rubber composition is preferably 10 to 300 mass %, more preferably 10 to 100 mass % of the amount of the sulfur-containing silane coupling agent used in combination therewith.

In the present invention, the organic silane having a terpene skeleton with a molecular weight of 200 to 1000 is preferably a compound represented by the following general formula (1):

[Formula 6]

X [symbol] S—CₙH₂ₙ—SiR¹R²R³]ₘ (1)
(wherein R¹, R², and R³ are each independently an alkyl group having 1 to 3 carbon atoms or an alkoxy group having 1 to 3 carbon atoms, at least one of R¹, R², and R³ is an alkoxy group, n is an integer of 2 to 4, X is a group having a terpene skeleton with a molecular weight of 200 to 1000, an intramolecular carbon-carbon double bond that X has is saturated or unsaturated, and X optionally contains a hetero element).

The organic silane used in the present invention is not limited as long as it is a compound having a terpene skeleton with a molecular weight of 200 to 1000, but a product of an ene-thiol reaction between a silicon-containing thiol compound and a compound having a terpene skeleton with a molecular weight of 200 to 1000 can more appropriately be used.

An example of the silicon-containing thiol compound is a silicon-containing thiol compound having a mercapto group and represented by the following general formula (2):

[Formula 7]

HS—CₙH₂ₙ—SiR¹R²R³ (2)
(wherein R¹, R², R³, and n are the same as those in the above formula (1)). A desired organic silane can be obtained through an ene-thiol reaction between a carbon-carbon double bond (C═C) that the compound having a terpene skeleton with a molecular weight of 200 to 1000 has and a mercapto group that the silicon-containing thiol compound having a mercapto group has. Specific examples of the compound represented by the general formula (2) include (3-mercaptopropyl)triethoxysilane, (3-mercaptopropyl)trimethoxysilane, (3-mercaptopropyl)methyldimethoxysilane, (3-mercaptopropyl)dimethylmethoxysilane, and mercaptoethyl triethoxysilane.

The compound having a terpene skeleton with a molecular weight of 200 to 1000 is not limited, and preferred examples thereof include a compound represented by the following general formula (3a)

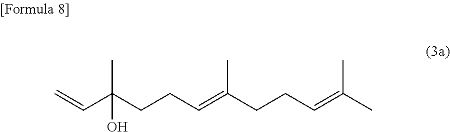

a compound represented by the following general formula (3b)

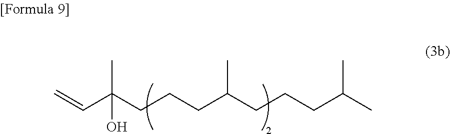

and a compound represented by the following general formula (3c)

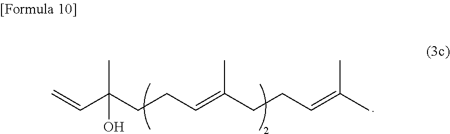

The compound represented by the general formula (3a), the compound represented by the general formula (3b), and the compound represented by the general formula (3c) may singly be subjected to an ene-thiol reaction with the silicon-containing thiol compound having a mercapto group to obtain an organic silane, or a mixture of at least two of these compounds or all of the three compounds may be subjected to an ene-thiol reaction with the silicon-containing thiol compound having a mercapto group to obtain an organic silane.

The ene-thiol reaction is preferably performed using a radical generator as a reaction catalyst. A radical reaction may be performed by ultraviolet (UV) irradiation. Examples of the radical generator include an azo compound and an organic peroxide. Such radical generators include one that generates radicals by heat and one that generates radicals by light irradiation. Examples of the azo compound include azobisisobutyronitrile (AIBN) and 1,1′-azobis(cyclohexanecarbonitrile) (ABCN). Examples of the organic peroxide include di-tert-butylperoxide, tert-butylhydroperoxide, benzoyl peroxide, and methyl ethyl ketone peroxide.

The ene-thiol reaction can be performed by, for example, mixing the compound represented by the general formula (2), the compound having a terpene skeleton with a molecular weight of 200 to 1000, and a radical generator together with an organic solvent such as toluene and maintaining the mixture under conditions for generating radicals. The reaction temperature is preferably 50 to 120° C.

The organic silane having a terpene skeleton with a molecular weight of 200 to 1000 has a monosulfide bond (—C—S—C—), which improves affinity for the diene-based rubber. Further, when the organic silane having a terpene skeleton with a molecular weight of 200 to 1000 lies at the interface between the diene-based rubber and the silica, the interface between them can be flexibilized at a high level because the terpene skeleton with a molecular weight of 200 to 1000 has high affinity for the diene-based rubber. Therefore, WET performance and fuel-efficiency of a vulcanized rubber of the rubber composition according to the present invention are improved in a balanced way due to excellent dispersibility of the silica in the rubber and a very flexible interface between them.

The organic silane having a terpene skeleton with a molecular weight of 200 to 1000 used in the present invention is preferably a compound represented by the above general formula (1), particularly preferably a compound represented by the following general formula (4a):

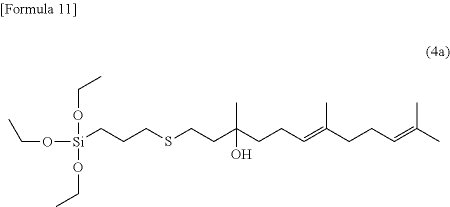

a compound represented by the following general formula (4b)

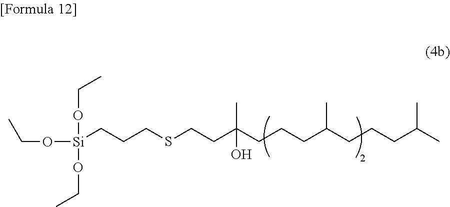

or a compound represented by the following general formula (4c)

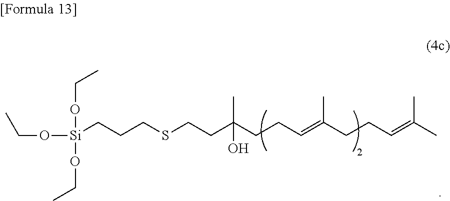

The method for producing a rubber composition according to the present invention uses also, in addition to the organic silane having a terpene skeleton with a molecular weight of 200 to 1000, a sulfur-containing silane coupling agent other than the organic silane as a raw material. This makes it possible to produce a rubber composition achieving a good balance among improved three performances: wear resistance as well as WET performance and fuel-efficiency.

Examples of the sulfur-containing silane coupling agent other than the organic silane that is a compound having a terpene skeleton with a molecular weight of 200 to 1000 include: sulfidesilanes such as bis(3-triethoxysilylpropyl)tetrasulfide (e.g., “Si69” manufactured by Evonik Japan Co., Ltd.), bis(3-triethoxysilylpropyl)disulfide (e.g., “Si75” manufactured by Evonik Japan Co., Ltd.), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

In the present invention, the amount of the sulfur-containing silane coupling agent contained in the rubber composition is preferably 1 to 15 mass %, more preferably 1 to 10 mass % of the amount of the silica contained in the rubber composition.

In the method for producing a rubber composition according to the present invention, in addition to the diene-based rubber, the silica, the organic silane that is a compound having a terpene skeleton with a molecular weight of 200 to 1000, and the silane coupling agent other than the organic silane, carbon black, a vulcanizing agent, a vulcanization accelerator, an antiaging agent, stearic acid, a softener such as wax or oil, a processing aid, and others may be blended.

Examples of the carbon black that can be used include carbon blacks usually used in the rubber industry, such as SAF, ISAF, HAF, FEF, and GPF; and conductive carbon blacks such as acetylene black and ketjen black.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the vulcanizing agent in the rubber composition according to the present invention is preferably 0.5 to 3.5 parts by mass when the entire amount of the diene-based rubber is taken as 100 parts by mass.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination of two or more of them.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

The method for producing a rubber composition according to the present invention is a method for producing a rubber composition containing a diene-based rubber, silica, an organic silane, and a sulfur-containing silane coupling agent other than the organic silane, wherein the organic silane is a compound having a terpene skeleton with a molecular weight of 200 to 1000, the method including: a first step in which at least the diene-based rubber, the silica, and the sulfur-containing silane coupling agent are mixed to obtain a rubber composition before remilling; and a second step in which the rubber composition before remilling and the organic silane are mixed.

In the first step and the second step, a kneading machine usually used in the rubber industry, such as a Banbury mixer, a kneader, or a roll can be used.

In the first step, at least the diene-based rubber, the silica, and the sulfur-containing silane coupling agent are mixed to obtain a rubber composition before remilling. Conditions for performing the first step are not limited. For example, the first step may be performed using, for example, the kneading machine described above under kneading conditions of 100 to 200° C. and 200 to 300 seconds.

In the second step, the rubber composition before remilling and the organic silane are mixed. Conditions for performing the second step are not limited, either. For example, the second step may be performed using, for example, the kneading machine described above under kneading conditions of 100 to 200° C. and 100 to 200 seconds.

A vulcanized rubber of a rubber composition produced by the method for producing a rubber composition according to the present invention achieves a good balance among improved three performances: WET performance, fuel-efficiency, and wear resistance. Therefore, a vulcanized rubber of a rubber composition produced by the method for producing a rubber composition according to the present invention is particularly useful for pneumatic tire treads.

### EXAMPLES

Hereinbelow, the present invention will more specifically be described with reference to examples.

### [Preparation of Rubber Composition and Vulcanized Rubber]

### Comparative Example 1 to Comparative Example 12

According to each of formulations (parts by mass) shown in Table 1 to Table 10, a rubber component was subjected to mastication for 30 seconds with the use of a labo mixer (300 cc) manufactured by DAIHAN CO., LTD., silica, a sulfur-containing silane coupling agent, an organic silane, zinc oxide, stearic acid, and oil were then added thereto, and the resultant was kneaded for 240 seconds. Then, the thus obtained rubber composition was discharged. Then, the discharged rubber composition was charged into the labo mixer and kneaded for 180 seconds and then discharged. Further, the discharged rubber composition, sulfur, and a vulcanization accelerator were charged into the labo mixer and kneaded for 60 seconds. Then, the thus obtained unvulcanized rubber composition was discharged. The unvulcanized rubber composition was subjected to sheeting using two rolls to have a thickness of 2 mm and was then subjected to vulcanizing press at 160° C. for 20 minutes to obtain a vulcanized sample.

### Example 1 to Example 10

According to each of formulations (parts by mass) shown in Table 1 to Table 10, a rubber component was subjected to mastication for 30 seconds with the use of a labo mixer (300 cc) manufactured by DAIHAN CO., LTD., silica, a sulfur-containing silane coupling agent, zinc oxide, stearic acid, and oil were then added thereto, and the resultant was kneaded for 240 seconds and then discharged from the labo mixer. In this way, a rubber composition before remilling was obtained (first step). Then, the discharged rubber composition before remilling and an organic silane were charged into the labo mixer and kneaded for 180 seconds and then discharged from the labo mixer (second step). Further, the discharged rubber composition, sulfur, and a vulcanization accelerator were charged into the labo mixer and kneaded for 60 seconds. Then, the thus obtained unvulcanized rubber composition was discharged. The unvulcanized rubber composition was subjected to sheeting using two rolls to have a thickness of 2 mm and was then subjected to vulcanizing press at 160° C. for 20 minutes to obtain a vulcanized sample. The compounding agents shown in Table 1 to Table 10 are as follows.

### (Diene-Based Rubber)

SBR: “HPR350” manufactured by ENEOS Materials Corporation, amine-terminated modified S-SBR

### (Silica)

“Nipsil AQ” manufactured by Tosoh Corporation

### (Silane Coupling Agent (Sulfur-Containing Silane Coupling Agent))

“Si75” manufactured by Evonik Japan Co., Ltd.

### (Organic Silane)

Organic silane (1) (compound having terpene skeleton with molecular weight of 200 to 1000): one produced by the following synthetic method 1

### (Synthetic Method 1)

First, 46.6 g of nerolidol (manufactured by Tokyo Chemical Industry Co., Ltd.) represented by the above general formula (3a), 50.0 g of (3-mercaptopropyl)triethoxysilane (manufactured by Tokyo Chemical Industry Co., Ltd.), 3.4 g of 2,2′-azobis(isobutylnitrile) (manufactured by Wako Pure Chemical Industries, Ltd.), and 100 mL of toluene were mixed in an eggplant flask, and the mixture was subjected to bubbling with nitrogen gas for 30 minutes and then subjected to reaction at 70° C. for 24 hours. Then, the reaction solution was concentrated to obtain 94.8 g of a pale yellow liquid (yield: 98 mass %). As a result of NMR measurement, the product was confirmed to be nerolidol silane represented by the above general formula (4a). The product was defined as an “organic silane (1)”.
Organic silane (2) (compound having terpene skeleton with molecular weight of 200 to 1000): one produced by the following synthetic method 2

### (Synthetic Method 2)

First, 60.9 g of geranyl-linalool (manufactured by Tokyo Chemical Industry Co., Ltd.) represented by the above general formula (3b), 50.0 g of (3-mercaptopropyl)triethoxysilane (manufactured by Tokyo Chemical Industry Co., Ltd.), 3.4 g of 2,2′-azobis(isobutylnitrile) (manufactured by Wako Pure Chemical Industries, Ltd.), and 100 mL of toluene were mixed in an eggplant flask, and the mixture was subjected to bubbling with nitrogen gas for 30 minutes and then subjected to reaction at 70° C. for 24 hours. Then, the reaction solution was concentrated to obtain 109.2 g of a pale yellow liquid (yield: 98 mass %). As a result of NMR measurement, the product was confirmed to be geranyl-linalool silane represented by the above general formula (4b). The product was defined as an “organic silane (2)”.
Organic silane (3) (compound having terpene skeleton with molecular weight of 200 to 1000): one produced by the following synthetic method 3

### (Synthetic Method 3)

First, 62.2 g of isophytol (manufactured by Tokyo Chemical Industry Co., Ltd.) represented by the above general formula (3c), 50.0 g of (3-mercaptopropyl)triethoxysilane (manufactured by Tokyo Chemical Industry Co., Ltd.), 3.4 g of 2,2′-azobis(isobutylnitrile) (manufactured by Wako Pure Chemical Industries, Ltd.), and 100 mL of toluene were mixed in an eggplant flask, and the mixture was subjected to bubbling with nitrogen gas for 30 minutes and then subjected to reaction at 70° C. for 24 hours. Then, the reaction solution was concentrated to obtain 111.0 g of a pale yellow liquid (yield: 99 mass %). As a result of NMR measurement, the product was confirmed to be isophytol silane represented by the above general formula (4c). The product was defined as an “organic silane (3)”.

### (Other Compounding Agents)

Zinc white (zinc oxide): “Zinc Oxide Grade 3” manufactured by MITSUI MINING & SMELTING CO., LTD.
Stearic acid: “LUNAC S-20” manufactured by Kao Corporation
Sulfur: “Powder Sulfur” manufactured by Tsurumi Chemical Industry Co., ltd.
Vulcanization accelerator (1): “SOXINOL CZ” manufactured by SUMITOMO CHEMICAL COMPANY, LIMITED
Vulcanization accelerator (2): “NOCCELER D” manufactured by OUCHI SHINKO CHEMICAL INDUSTRIAL CO., LTD.

The obtained vulcanized rubber sample was evaluated according to the following criteria.

### [Wet Performance (Wet Grip Performance)]

A loss coefficient tan δ was measured at a frequency of 10 Hz, a static strain of 10%, a dynamic strain of 1%, and a temperature of 0° C. using a viscoelasticity tester manufactured by Ueshima Seisakusho Co., Ltd. In Table 1 to Table 10, WET performance was expressed as index numbers determined when the loss coefficients of Comparative Example 2, Comparative Example 3, Comparative Example 4, Comparative Example 5, Comparative Example 6, Comparative Example 7, Comparative Example 8, Comparative Example 10, Comparative Example 11, and Comparative Example 12 were taken as 100, respectively. A larger index number indicates that tan δ is larger, that is, a tire excellent in wet grip performance can be obtained.

### [Fuel-Efficiency (Low Heat Build-Up)]

A loss coefficient tan δ was measured at a frequency of 10 Hz, a static strain of 10%, a dynamic strain of 1%, and a temperature of 60° C. using a viscoelasticity tester manufactured by Ueshima Seisakusho Co., Ltd. In Table 1 to Table 10, low heat build-up was expressed as index numbers determined when the loss coefficients of Comparative Example 2, Comparative Example 3, Comparative Example 4, Comparative Example 5, Comparative Example 6, Comparative Example 7, Comparative Example 8, Comparative Example 10, Comparative Example 11, and Comparative Example 12 were taken as 100, respectively. A smaller index number indicates that tan δ is smaller, that is, a tire excellent in low heat build-up can be obtained.

### [Wear Resistance Performance]

In accordance with JIS K6264, a wear loss was measured using a Lambourn abrasion tester manufactured by Iwamoto Seisakusho K.K. under conditions of a load of 40 N and a slip ratio of 30%. In Table 1 to Table 10, wear resistance performance was expressed as index numbers determined when the reciprocals of measured values of Comparative Example 2, Comparative Example 3, Comparative Example 4, Comparative Example 5, Comparative Example 6, Comparative Example 7, Comparative Example 8, Comparative Example 10, Comparative Example 11, and Comparative Example 12 were taken as 100, respectively. A larger index number indicates that wear resistance performance is more excellent.

TABLE 1

| | Comparative | Comparative | |
|---|---|---|---|
| | Example 1 | Example 2 | Example 1 |
| SBR | 100 | 100 | 100 |
| Silica | 75 | 75 | 75 |
| Zinc white | 2 | 2 | 2 |
| Stearic acid | 2 | 2 | 2 |
| Silane coupling agent | 6 | 3 | 3 |
| Organic silane (1) | — | 3 | 3 |
| Organic silane (2) | — | — | — |
| Organic silane (3) | — | — | — |
| Sulfur | 1.8 | 1.8 | 1.8 |
| Vulcanization | 1.3 | 1.3 | 1.3 |
| accelerator (1) | | | |
| Vulcanization | 1.3 | 1.3 | 1.3 |
| accelerator (2) | | | |
| Wet grip performance | 94 | 100 | 103 |
| Low heat build-up | 107 | 100 | 98 |
| Wear resistance | 117 | 100 | 101 |

TABLE 2

| | Comparative | |
|---|---|---|
| | Example 3 | Example 2 |
| SBR | 100 | 100 |
| Silica | 75 | 75 |
| Zinc white | 2 | 2 |
| Stearic acid | 2 | 2 |
| Silane coupling agent | 3 | 3 |
| Organic silane (1) | — | — |
| Organic silane (2) | 3 | 3 |
| Organic silane (3) | — | — |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 105 |
| Low heat build-up | 100 | 97 |
| Wear resistance | 100 | 100 |

TABLE 3

| | Comparative | |
|---|---|---|
| | Example 4 | Example 3 |
| SBR | 100 | 100 |
| Silica | 75 | 75 |
| Zinc white | 2 | 2 |
| Stearic acid | 2 | 2 |
| Silane coupling agent | 3 | 3 |
| Organic silane (1) | — | — |
| Organic silane (2) | — | — |
| Organic silane (3) | 3 | 3 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 106 |
| Low heat build-up | 100 | 95 |
| Wear resistance | 100 | 101 |

TABLE 4

| | Comparative | |
|---|---|---|
| | Example 5 | Example 4 |
| SBR | 100 | 100 |
| Silica | 75 | 75 |
| Zinc white | 2 | 2 |
| Stearic acid | 2 | 2 |
| Silane coupling agent | 3 | 3 |
| Organic silane (1) | — | — |
| Organic silane (2) | — | — |
| Organic silane (3) | 6 | 6 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 106 |
| Low heat build-up | 100 | 96 |
| Wear resistance | 100 | 103 |

TABLE 5

| | Comparative | |
|---|---|---|
| | Example 6 | Example 5 |
| SBR | 100 | 100 |
| Silica | 75 | 75 |
| Zinc white | 2 | 2 |
| Stearic acid | 2 | 2 |
| Silane coupling agent | 3 | 3 |
| Organic silane (1) | — | — |
| Organic silane (2) | — | — |
| Organic silane (3) | 9 | 9 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 107 |
| Low heat build-up | 100 | 96 |
| Wear resistance | 100 | 101 |

TABLE 6

| | Comparative | |
|---|---|---|
| | Example 7 | Example 6 |
| SBR | 100 | 100 |
| Silica | 75 | 75 |
| Zinc white | 2 | 2 |
| Stearic acid | 2 | 2 |
| Silane coupling agent | 6 | 6 |
| Organic silane (1) | — | — |
| Organic silane (2) | — | — |
| Organic silane (3) | 6 | 6 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 109 |
| Low heat build-up | 100 | 95 |
| Wear resistance | 100 | 103 |

-

TABLE 7

| | Comparative | |
|---|---|---|
| | Example 8 | Example 7 |
| SBR | 100 | 100 |
| Silica | 75 | 75 |
| Zinc white | 2 | 2 |
| Stearic acid | 2 | 2 |
| Silane coupling agent | 6 | 6 |
| Organic silane (1) | — | — |
| Organic silane (2) | — | — |
| Organic silane (3) | 12 | 12 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 110 |
| Low heat build-up | 100 | 94 |
| Wear resistance | 100 | 102 |

TABLE 8

| | Comparative | Comparative | |
|---|---|---|---|
| | Example 9 | Example 10 | Example 8 |
| SBR | 100 | 100 | 100 |
| Silica | 50 | 50 | 50 |
| Zinc white | 2 | 2 | 2 |
| Stearic acid | 2 | 2 | 2 |
| Silane coupling agent | 4 | 2 | 2 |
| Organic silane (2) | — | 2 | 2 |
| Organic silane (3) | — | — | — |
| Sulfur | 1.8 | 1.8 | 1.8 |
| Vulcanization | 1.3 | 1.3 | 1.3 |
| accelerator (1) | | | |
| Vulcanization | 1.3 | 1.3 | 1.3 |
| accelerator (2) | | | |
| Wet grip performance | 92 | 100 | 102 |
| Low heat build-up | 109 | 100 | 98 |
| Wear resistance | 135 | 100 | 118 |

TABLE 9

| | Comparative | |
|---|---|---|
| | Example 11 | Example 9 |
| SBR | 100 | 100 |
| Silica | 50 | 50 |
| Zinc white | 2 | 2 |
| Stearic acid | 2 | 2 |
| Silane coupling agent | 2 | 2 |
| Organic silane (2) | — | — |
| Organic silane (3) | 2 | 2 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 103 |
| Low heat build-up | 100 | 97 |
| Wear resistance | 100 | 114 |

TABLE 10

| | Comparative | |
|---|---|---|
| | Example 12 | Example 10 |
| SBR | 100 | 100 |
| Silica | 50 | 50 |
| Zinc white | 2 | 2 |
| Stearic acid | 2 | 2 |
| Silane coupling agent | 2 | 2 |
| Organic silane (2) | — | — |
| Organic silane (3) | 4 | 4 |
| Sulfur | 1.8 | 1.8 |
| Vulcanization | 1.3 | 1.3 |
| accelerator (1) | | |
| Vulcanization | 1.3 | 1.3 |
| accelerator (2) | | |
| Wet grip performance | 100 | 105 |
| Low heat build-up | 100 | 94 |
| Wear resistance | 100 | 107 |

As can be seen from the results shown in Table 1 to Table 10, vulcanized rubbers of rubber compositions produced in Examples 1 to 10 in which a first step of mixing at least a diene-based rubber, silica, and a sulfur-containing silane coupling agent to obtain a rubber composition before remilling and a second step of mixing the rubber composition before remilling and an organic silane having a terpene skeleton with a molecular weight of 200 to 1000 are separately performed achieve a good balance among improved three performances: WET performance, fuel-efficiency, and wear resistance as compared to Comparative Example 1 to Comparative Example 12 in which an organic silane having a terpene skeleton with a molecular weight of 200 to 1000 and a sulfur-containing silane coupling agent other than the organic silane are mixed with silica at the same time.

What is claimed is:

1. A method for producing a rubber composition containing a diene-based rubber, silica, an organic silane, and a sulfur-containing silane coupling agent other than the organic silane,
wherein the organic silane is a compound having a terpene skeleton with a molecular weight of 200 to 1000,
the method comprising:
a first step in which at least the diene-based rubber, the silica, and the sulfur-containing silane coupling agent are mixed to obtain a rubber composition before remilling; and
a second step in which the rubber composition before remilling and the organic silane are mixed.

2. The method for producing a rubber composition according to claim 1, wherein the organic silane is a compound represented by the following general formula (1):
[Formula 1]
X [symbol] S—CₙH₂ₙ—SiR¹R²R³]ₘ (1)
(wherein R¹, R², and R³ are each independently an alkyl group having 1 to 3 carbon atoms or an alkoxy group having 1 to 3 carbon atoms, at least one of R¹, R², and R³ is an alkoxy group, n is an integer of 2 to 4, X is a group having a terpene skeleton with a molecular weight of 200 to 1000, an intramolecular carbon-carbon double bond that X has is saturated or unsaturated, and X optionally contains a hetero element).

3. The method for producing a rubber composition according to claim 1, wherein the organic silane is a product of an ene-thiol reaction between a compound represented by the following general formula (2):
[Formula 2]
HS—CₙH₂ₙ—SiR¹R²R³ (2)
(wherein R¹, R², R³, and n are the same as those in the above formula (1)) and at least one compound selected from the group consisting of a compound represented by the following general formula (3a): 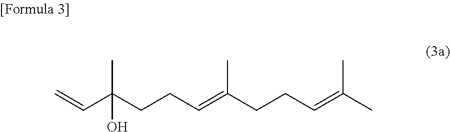
a compound represented by the following general formula (3b): 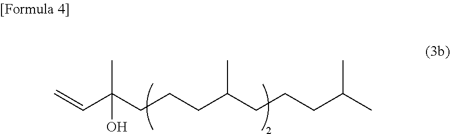
and a compound represented by the following general formula (3c):

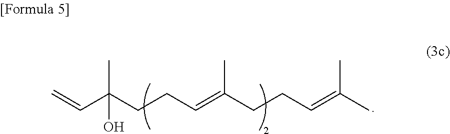

4. The method for producing a rubber composition according to claim 1, wherein in the first step, the silica is mixed in an amount of 30 to 150 parts by mass when an entire amount of the diene-based rubber is taken as 100 parts by mass and the sulfur-containing silane coupling agent is mixed in an amount of 1 to 15 mass % of the amount of the silica, and in the second step, the organic silane in an amount of 10 to 300 mass % of the amount of the sulfur-containing silane coupling agent is mixed with the rubber composition before remilling.
